(19) United States
(12) Patent Application Publication
(10) Pub. No.: US 2008/0138003 A1
(43) Pub. Date: Jun. 12, 2008

(54) Support Member For a Rotatable Element

(76) Inventor: Samuel Tsui, Hong Kong (CN)

Correspondence Address: BERENATO, WHITE & STAVISH, LLC, 6550 ROCK SPRING DRIVE, SUITE 240, BETHESDA, MD, 20817, US

(21) Appl. No.: 11/795,972

(22) PCT Filed: Jan. 25, 2006
(86) PCT No.: PCT/AU06/00079

§ 371 Date: Jul. 25, 2007

(30) Foreign Application Priority Data
Jan. 25, 2005 (AU) 2005900284

(51) Int. Cl. F16C 35/04; F16C 27/04

(52) U.S. Cl. 384/215; 384/428

(57) ABSTRACT

A support member 10 for a rotatable element 42 comprising at least two pairs of ribs 30, 32 attached to opposing sides 22 of the support member 10, each pair of ribs 30, 32 adapted to receive guide walls 38 of a housing for the rotatable element 42 tightly therein; a supporting end 18 between the opposing sides 22 into which the rotatable element 42 can be received and supported along its axial length; and a retaining end 20 between the opposing sides 22, and opposite the supporting end 18, adapted to restrict axial movement of the rotatable element 42 when received within the supporting end 18.

### FIELD OF THE INVENTION

The invention relates to a support member for a rotatable element. In particular, the invention relates to a support member for a rotatable process element in which the longitudinal position of the rotatable process element is controlled by the support member.

### BACKGROUND TO THE INVENTION

The following discussion of the background of the invention is intended to facilitate an understanding of the present invention. However, it should be appreciated that the discussion is not an acknowledgment or admission that any of the material referred to was published, known or part of the common general knowledge in any jurisdiction as at the priority date of the application.

Prior art process cartridges have retained the primary charge roller using a support clip. However, the construction of such support clips has been prone to breakage when the process cartridge is dropped on an end in which the support clip is retained. When the support clip is broken, the primary charge roller is then free to move which may result in:
the primary charge roller losing contact with its electricity source; and/or
an unevenness in pressure being applied along the length of the primary charge roller to the photosensitive drum.

It is an object of the present invention to provide a support member that overcomes, or at least ameliorates in part, one or more of the above problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is a support member for a rotatable element comprising:
at least two pairs of ribs attached to opposing sides of the support member, each pair of ribs adapted to receive guide walls of a housing for the rotatable element tightly therein;
a supporting end between the opposing sides into which the rotatable element can be received and supported along part of its axial length; and
a retaining end between the opposing sides, and opposite the supporting end, adapted to restrict axial movement of the rotatable element when received within the supporting end.

In one configuration, the rotatable element has a circular shaft able to be retained within the supporting end and the retaining end has an aperture provided therein of smaller diameter than the circular shaft. In an alternate configuration, the rotatable element has a circular shaft able to be retained within the supporting end and the retaining end is a cross-piece extending between the opposing sides at the position of the circular shaft when the circular shaft is retained within the supporting end.

The rotatable element may be received within an end cap and the end cap is received and supported by the supporting end.

Preferably, the support member also includes a base connecting the retaining end, supporting end and opposing sides, the base being connected to the housing by a resilient means. The resilient means may take the form of a spring.

Ideally, a rib from each of the at least two pairs of ribs is positioned so as to be flush with the supporting end.

In accordance with a second aspect of the present invention there is a rotatable element including a support member according to the first aspect of the invention.

In accordance with a third aspect of the present invention there is a cartridge including a support member according to the first aspect of the invention.

### BRIEF DESCRIPTION OF THE DRAWINGS

The invention will now be described, by way of example only, with reference to the accompanying drawings, in which:

FIG. 1 is an isometric view of a support member according to the present invention.

FIG. 2 is a top plan view of a support member as shown in FIG. 1 having received a portion of a rotatable element therein.

FIG. 3 is a side plan view of the support member as shown in FIG. 1 having received a portion of a rotatable element therein.

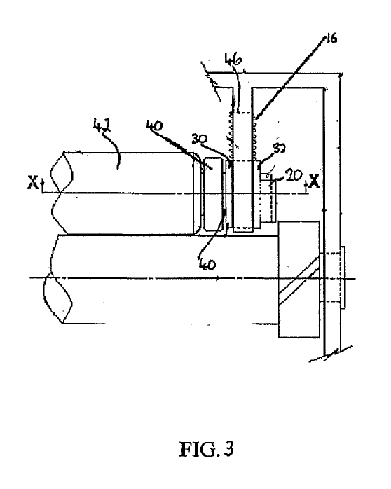

### PREFERRED EMBODIMENTS OF THE INVENTION

In accordance with the preferred embodiment of the invention there is a support member 10.

The support member 10 has a circular protrusion 12 extending from its base 14. A circular spring 16 also extends away from the base 14. The circular spring 16 remains in contact with the base 14 by virtue of its tight encircling of the circular protrusion 12.

Extending away from the base 14 at a side opposite the circular protrusion 12 is a front wall 18, a rear wall 20 and side walls 22. The front wall 18 has a substantially circular aperture 24 provided therein. The circular aperture 24 is truncated at the position where it intersects open area 26.

The rear wall 20 has a circular hole 28 provided therein. The centre of the circular hole 28 is substantially co-axial with the centre of the circular aperture 24.

Each side wall 22 has two ribs 30, 32 protruding therefrom. The first rib 30 protrudes from the side wall 22 at the position flush with the front wall 18. In this manner, the first rib 30 looks to be integral with the front wall 18.

The second rib 32 protrudes from the side wall 22 at a position spaced from the rear wall 20 and the front side 30. Second rib 32 has a lower profile than first rib 30. The combination of the side wall 22 and the two ribs 30, 32 produce a channel 34.

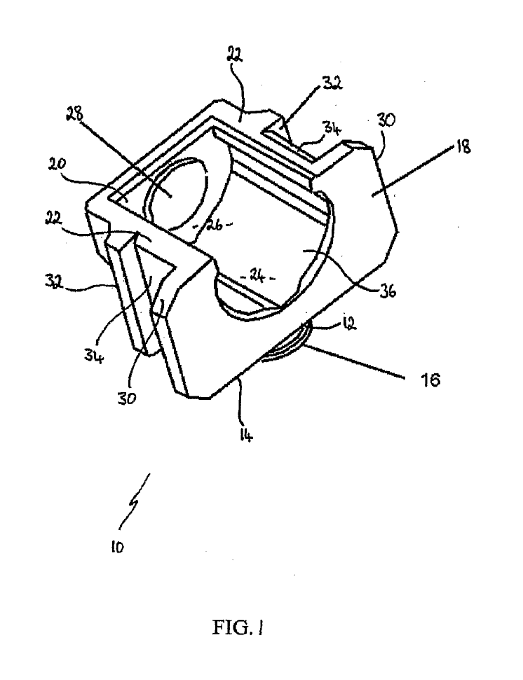

The inner surface 36 of the area bounded by base 14, front wall 18, rear wall 20 and side walls 22 is substantially cylindrical in profile with the front wall 18 and rear wall 20 acting as the ends of the cylinder. This is shown graphically in FIG. 1.

The preferred embodiment will now be described in the context of its intended use.

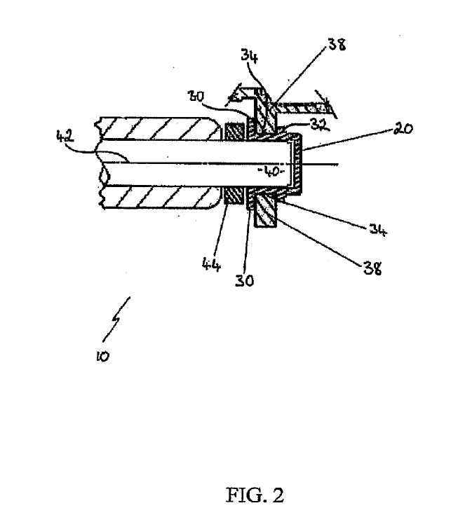

As is shown in FIG. 2, the support member 10 is received within a process cartridge (not shown) by way of guide walls 38 being received within channels 34. In this position, the support member 10 is also adapted to receive the ends of a shaft 40 of the rotatable element 42 (in this case a charging roller). The shaft 40 has a contour that approximates the substantially cylindrical profile of the inner surface 36.

Encircling the shaft 40 is a spacer 44. The spacer 44 separates the main body 46 of the rotatable element 42 from the support member 10. The spacer 44 is of a similar size to the support member 10.

The advantage of this configuration is that any axial movement of the rotatable element 42 is contained by the rear wall 20 of the support member 10 and not by any external element of the process cartridge (not shown).

Additionally, the unattached end of the circular spring 16 tightly encircles a circular stud (not shown) at the base 46 that joins the guide walls 38. The uncompressed force of the circular spring 16 then properly positions the support member 10 along the glide walls 38. In the embodiment being described, this also allows the support member 10 to regulate the appropriate level of contact pressure being applied to the photosensitive drum by the charging roller.

It should be appreciated by the person skilled in the art that the above invention is not limited to the embodiment described. In particular, the following modifications and improvements may be made without departing from the scope of the present invention:
Rear wall 20 may be substantially open with a support brace being positioned so as to restrict any axial movement of the rotatable element.
The shaft 40 may be retained within an open cylinder end cap. The open cylinder end cap forming part of the support member 10 as a protective covering for inner surface 36.
The circular spring 16 may be omitted or replaced with other resilient means.
While the invention has been described in the context of primary charge roller for a process cartridge, the invention may be applied to other cartridge types, such as a developer cartridge, and for other rotatable elements, such as the developer roller.

It should be further appreciated by the person skilled in the art that the features described in one embodiment, where not mutually exclusive or alternatives, may be combined with features described in other embodiments to create yet further embodiments that fall within the scope of the present invention.

1. A support member for a rotatable element comprising:
at least two pairs of ribs attached to opposing sides of the support member, each pair of ribs adapted to receive guide walls of a housing for the rotatable element tightly therein;
a supporting end between the opposing sides into which the rotatable element can be received and supported along part of its axial length; and
a retaining end between the opposing sides, and opposite the supporting end, adapted to restrict axial movement of the rotatable element when received within the supporting end.

2. A support member for a rotatable element according to claim 1, where the rotatable element has a circular shaft able to be retained in part within the supporting end and the retaining end has an aperture provided therein of smaller diameter than the circular shaft.

3. A support member for a rotatable element according to claim 1, where the rotatable element has a circular shaft able to be retained in part within the supporting end and the retaining end is a cross-piece extending between the opposing sides at the position of the circular shaft when the circular shaft is retained within the supporting end.

4. A support member for a rotatable element according to claim 1, where the rotatable element is received in part within an end cap and the end cap is received and supported by the supporting end.

5. A support member for a rotatable element according to claim 1, further including a base connecting the retaining end, supporting end and opposing sides, the base being connected to the housing by a resilient means.

6. A support member for a rotatable element according to claim 5, where the resilient means is a spring.

7. A support member for a rotatable element according to claim 1, where a rib from each of the at least two pairs of ribs is positioned so as to be flush with the supporting end.

8. A rotatable element including a support member according to claim 1.

9. A cartridge including a support member according to claim 1.

10-12. (canceled)
